(19) United States
(12) Patent Application Publication
(10) Pub. No.: US 2012/0226490 A1
(43) Pub. Date: Sep. 6, 2012

(54) CONTENT SENSITIVE SYSTEM AND METHOD FOR AUTOMATIC INPUT LANGUAGE SELECTION

(76) Inventor: Eliyahu Mashiah, Ramat Gan (IL)

(21) Appl. No.: 13/383,032

(22) PCT Filed: Jul. 7, 2010
(86) PCT No.: PCT/IL10/00542

§ 371 Date: Apr. 24, 2012

Related U.S. Application Data
(60) Provisional application No. 61/224,104, filed on Jul. 9, 2009.

(51) Int. Cl. G06F 17/20

(52) U.S. Cl. 704/8

(57) ABSTRACT

The present invention discloses a computer system for providing an automatic selection of input language according to a content of the input text typed by a computer user. The system comprises a plurality of text input fields to receiving text characters by the input means; each the text input field is uniquely identified by Application/Document/Field triplet; a tagging algorithm for tagging each the input field with the default input language based on the data in the database related to the input field; and a language selection algorithm for automatic selection of typing language in the input field to the default input language of the input field. The default input language of each the input field is predetermined by the tagging algorithm according to the language properties of each the input field.

### FIELD OF THE INVENTION

The present invention generally pertains to user interfaces and more particularly to a system and methods for automatic selection of inputting language for typing input text in a specific input field.

### BACKGROUND OF THE INVENTION

The present invention pertains to system and methods for automatic selection of inputting language for typing input text in a specific input field.

Today, a user of a multi-language operation system must select between one language to a second (or third and consequent) language manually (e.g., by pressing alt+shift keys or selecting an icon presented in his Windows operation system). It is a common event when the user begins to type a text in a language which is different from the language he intended to type. As a result of that, after typing a few characters/words, when looking at the screen, the user recognizes that he is typing in the wrong language. After that, the user deletes the incorrect text, switches to the right typing language, and rewrites the text. This process of text correction causes waste of time and is inefficient, inconvenient, annoying, etc.

It is therefore a long felt need to provide a system and a method to prevent this process of incorrect text typing and to provide a user friendly solution to the described above common problem.

### SUMMARY OF THE INVENTION

The present invention discloses a computer system for providing an automatic selection of input language according to a content of the input text typed by a computer user. The computer system comprises:
a. A computer operative to execute program code that comprises: a monitor, an input means, an operating system with a graphic user interface (GUI) unit adapted to establish interface between the computer and the user;
b. A plurality of text input fields to receiving text characters by the input means. The input fields and the text characters are displayed on the monitor by the GUI.
   Each text input field is uniquely identified by Application/Document/Field triplet.
c. A database located in the memory of the computer for storing the type of each input field, the language properties of each input field and the default input language tag of each input field as previously selected by the user;
d. A tagging algorithm for tagging each the input field with the default input language based on the data in the database related to the input field; and
e. A language selection algorithm for automatic selection of typing language in the input field to the default input language of the input field. The language selection is performed in the operating system.

The default input language of each input field is predetermined by the tagging algorithm according to the language properties of each input field. Further wherein the language selection algorithm is responsive to the last user's selection of the input field by the input means, and such that the linguistic meaning of a sequence of text characters that is received in the input field is understandable by the user.

The present invention also discloses a computer system as described above, wherein said memory is the RAM of said computer.

The present invention also discloses a computer system as described above, wherein said memory is the hard-drive of said computer.

The present invention also discloses a computer system as described above, wherein the input means is selected from a group consisting of: a keyboard, a mouse, a touch screen, a hand-writing recognition system that translates hand written scripts to character input or any combination thereof.

The present invention also discloses a computer system as described above, wherein the tagging algorithm is based on statistical calculations and predetermined thresholds. Te thresholds are adapted for supporting the tagging algorithm in the tagging.

The present invention also discloses a computer system as described above, wherein the language properties of the input field is the language of the text characters previously received in the input field.

The present invention also discloses a computer system as described above, wherein the previously received is the last time the text characters were received in the input field.

The present invention also discloses a computer system as described above, wherein the language properties are the language of the text that is associated with the input field.

The present invention also discloses a computer system as described above, wherein the language properties are the language of the caption of the input field.

The present invention also discloses a computer system as described above, wherein the language properties are the language of the text that surrounds the input field.

The present invention also discloses a computer system as described above, wherein the statistical calculations are selected from the group consisting of: Summation, Mean calculation, Variance calculation, Standard Deviation calculation, Expectancy calculation and any combination thereof.

The present invention also discloses a computer system as described above, wherein the database further comprising the text characters previously received in the input field with a predetermined number of characters that are saved in the database.

The present invention also discloses a computer system as described above, wherein the statistical calculations are performed on the text characters previously received in the input field.

The present invention also discloses a computer system as described above, wherein the database further comprising the history of the default input language tags of the input field.

The present invention also discloses a computer system as described above, wherein the statistical calculations are performed on the history of the default input language tags.

The present invention also discloses a computer system as described above, wherein the statistical calculations are performed on the text characters.

The present invention also discloses a computer system as described above, wherein the input field is a text field selected from a group consisting of a document editor file content field, a spreadsheet software content field, a presentation file content field, a url address field of an internet browser, a text field in a specific internet page, an input field in a user interface of a computer software, an input field of an operating system, an programming editor and any combination thereof.

The present invention also discloses a computer system as described above, wherein the database further comprising the text of the name of one of the: document editor file, spreadsheet software file, presentation file and a file of a programming editor;

The present invention also discloses a computer system as described above, wherein the statistical calculations are performed on the text of the name of the file.

The present invention also discloses a computer system as described above, wherein the type of the input field is a location of a document editor file, a location of a spreadsheet file, a location of a presentation file, a url address of an internet page, a location of computer software, a location of computer software editable file, a location of an operating system application and any combination thereof.

The present invention also discloses a computer system as described above, wherein said physical medium is selected from a group consisting of: a paper and a monitor.

The present invention also discloses a computer method for providing an automatic selection of input language. The method comprises:
a. Installing a computer system for providing an automatic selection of input language according to a content of the input text typed by a computer user. The system comprises:
   i. A computer operative to execute program code comprising: a monitor, input means controllable by the user, an operating system with a graphic user interface (GUI) unit adapted to establish interface between the computer and the user;
   ii. A plurality of text input fields to receiving text characters by the input means. The input fields and the text characters are displayed on the monitor by the GUI. Each text input field is uniquely identified by Application/Document/Field triplet;
   iii. A database located in the memory of the computer for storing the type of each input field, the language properties of each input field and the default input language tag of each input field as previously selected by the user;
   iv. A tagging algorithm for tagging each input field with the default input language based on the data in the database related to the input field; and
   v. A language selection algorithm for automatic selection of input language of the text characters in the input field. The selected input language is the default input language of the input field. The language selection is performed in the operating system.
      The default input language of each input field is predetermined by the tagging algorithm according to the language properties of each input field. Further wherein the language selection algorithm is responsive to the last user's selection of the input field by the input means, and such that the linguistic meaning of a sequence of text characters that is received in the input field is understandable by the user;
b. Actuating the computer system by the execute program code;
c. Receiving text characters in the input field by the input means controlled by the user;
d. Storing the language properties of the input field to the database;
e. Tagging the input field with the default input language by the tagging algorithm; and
f. Selecting the input language of the input field according to the default input language of the input field each time the user selects the input field by the input means.

The present invention also discloses a computer method as described above, wherein the input means is selected from a group consisting of: a keyboard, a mouse, a touch screen, a hand-writing recognition system that translates hand written scripts to character input or any combination thereof.

The present invention also discloses a computer method as described above, wherein said memory is the RAM of said computer.

The present invention also discloses a computer method as described above, wherein said memory is the hard-drive of said computer.

The present invention also discloses a computer method as described above, wherein the tagging algorithm is based on statistical calculations and predetermined thresholds. The thresholds are adapted for supporting the tagging algorithm in the tagging.

The present invention also discloses a computer method as described above, wherein the language properties of the input field is the language of the text characters previously received in the input field.

The present invention also discloses a computer method as described above, wherein the previously received is the last time the text characters were received in the input field.

The present invention also discloses a computer method as described above, wherein the language properties are the language of the text that is associated with the input field.

The present invention also discloses a computer method as described above, wherein the language properties are the language of the caption of the input field.

The present invention also discloses a computer method as described above, wherein the language properties are the language of the text that surrounds the input field.

The present invention also discloses a computer method as described above, wherein the statistical calculations are selected from the group consisting of: Summation, Mean calculation, Variance calculation, Standard Deviation calculation, Expectancy calculation and any combination thereof.

The present invention also discloses a computer method as described above, wherein the database further comprising the text characters previously received in the input field with a predetermined number of characters that are saved in the database.

The present invention also discloses a computer method as described above, wherein the statistical calculations are performed on the text characters previously received in the input field.

The present invention also discloses a computer method as described above, wherein the database further comprising the history of the default input language tags of the input field.

The present invention also discloses a computer method as described above, wherein the statistical calculations are performed on the history of the default input language tags.

The present invention also discloses a computer method as described above, wherein the statistical calculations are performed on the text characters.

The present invention also discloses a computer method as described above, wherein the input field is a text field selected from a group consisting of a document editor file content field, a spreadsheet software content field, a presentation file content field, a url address field of an internet browser, a text field in a specific internet page, an input field in a user interface of a computer software, an input field of an operating system, an programming editor and any combination thereof.

The present invention also discloses a computer method as described above, wherein the database further comprising the text of the name of one of the: document editor file, spreadsheet software file, presentation file and a file of a programming editor.

The present invention also discloses a computer method as described above, wherein the statistical calculations are performed on the text of the name of the file.

The present invention also discloses a computer method as described above, wherein the type of the input field is a location of a document editor file, a location of a spreadsheet file, a location of a presentation file, a url address of an internet page, a location of computer software, a location of computer software editable file, a location of an operating system application and any combination thereof.

The present invention also discloses a computer method as described above, wherein said physical medium is selected from a group consisting of: a paper and a monitor.

### BRIEF DESCRIPTION OF THE FIGURES

In order to better understand the invention and its implementation in a practice, a plurality of embodiments will now be described, by way of non-limiting example only, with reference to the accompanying drawings, in which

FIG. 1 illustrates the system of the present invention.

FIG. 2 illustrates examples of input fields.

FIG. 3 illustrates the method for tagging an input field with a default typing language.

FIG. 4 illustrates the method for automatic language selection by the system of the present invention.

### DETAILED DESCRIPTION OF THE PREFERRED EMBODIMENTS

The present invention pertains to system and methods for automatic selection of inputting language for typing input text in a specific input field.

The present invention solves the problem of inconvenient process of typing language selection in a multi-language operating system. This process is performed manually, thus leading to typing mistakes which lead to waste of time and inefficiency.

The present invention solves this problem by predicting the language in which the user is intended to write, and automatic selection of the input language to a specific language.

This prediction of the typing language by the system of the present invention is based on a previous knowledge about the type of the input text field, the language usually used in this input field by the specific user and the software in which the text is typed. For example, if the user wants to write a url address of a specific internet site in the internet browser, so when clicking on the address input text field in the browser, the typing language automatically will be switched to English. Another example to usage of the system of the present invention can be when the user opens a document file for its editing. In this case, if most of the text in this document file is in Hebrew, or for example, the name of the document file is in Hebrew, the system of the present invention will automatically switch the typing language to Hebrew (before the user begins the typing).

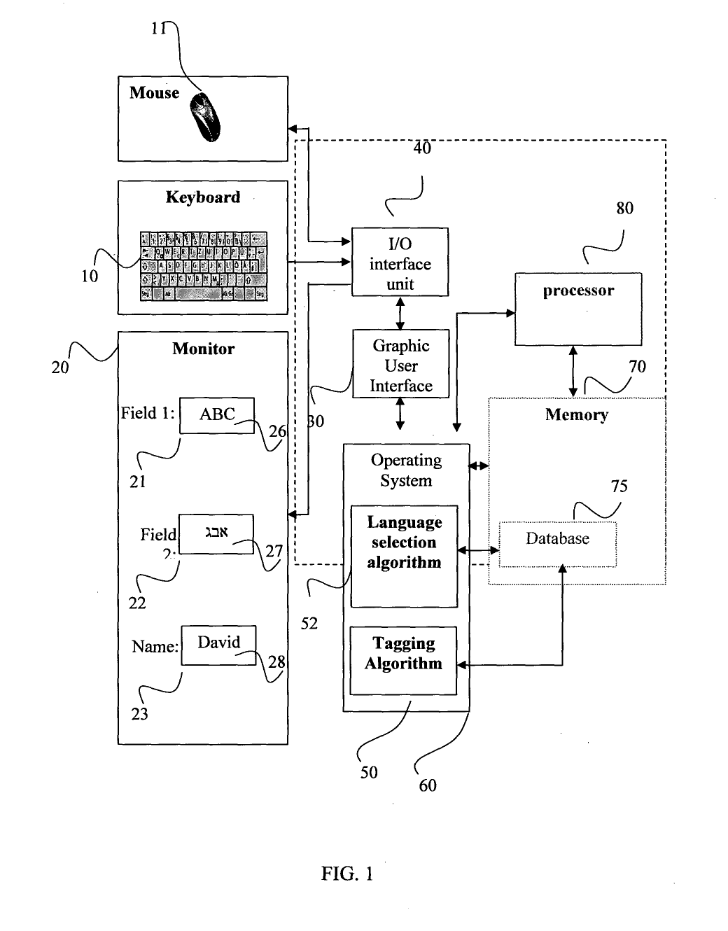

Reference is made now to FIG. 1 where a computer system 100 for providing an automatic selection of input language according to a content of the input text typed by a computer user. The system 100 comprises:
a. a computer operative to execute program code comprising: a monitor 20, input means (keyboard 10 and mouse 11), an operating system 60 with a graphic user interface (GUI) unit 30, a memory 70 coupled to a processor 80, an I/O interface unit 40 adapted to connect between a keyboard 10 for typing a sequence of text characters 26 and the operating system 50 and graphic user interface unit 30. The I/O interface unit 40 is also adapted to connect between the monitor 20 and the graphic user interface unit 30. The operating system 60 is adapted to establish interface between the memory 70, processor 80 and the user. The monitor 20 is adapted to display digital content generated by the graphic user interface 30.
b. a plurality of text input fields 21, 22 to receiving text characters 26, 27 by the keyboard 10. The input fields 21, 22 and the text characters 26, 27 are displayed on the monitor 20 by the GUI 30.
c. a database 75 located in the memory 70 of the computer for storing the type of each input field 21, 22, the language properties of each input field 21, 22 and the default input language tag of each input field 21, 22.
d. a tagging algorithm 50 operated by the operating system 60 for tagging each input field 21, 22 with the default input language based on the data in the database 75 related to the input field 21, 22.
e. a language selection algorithm 52 for automatic selection of typing language in the input field to the default input language of the input field; the language selection is performed in the operating system.

The default input language of each input field 21, 22 is predetermined by the tagging algorithm 50 according to the language properties of each input field; further wherein the language selection algorithm 52 is responsive to the user's selection of the input field by the mouse 11 or the keyboard 10. This means that when the user is intended to write a text in a specific input field 21, 22 and he click with the mouse on this field, the language selection algorithm 52 is activated. This activation results in an automatic selection of the typing language which is set to the predetermined default input language. This automatic language selection is the core of the present invention. The language properties of the input field 21, 22 is the language of the text characters 26, 27 previously received in the input field 21, 22 by the keyboard 10 which is activated by the user. For example, as presented in FIG. 1, the language of the text characters 26 is English, and the language of the text characters 27 is Hebrew. According to a specific embodiment of the present invention the previously received text is the last time the text characters 26, 27 were received in the input field. According to another embodiment of the present invention the language properties are the language of the text that is associated with the input field. For example, if the language of the caption of the input field 23 is “Name” (in English), so the default input language of text (“David”) 28 in this field will be English. If the caption of this field was in Hebrew, it is probably that the text in this field would be Hebrew. In this case, the tagging algorithm 50 of the system 100 of the present invention would tag the field with a default input language of Hebrew. According to another embodiment if the present invention, language properties of an input field are the language of the text that surrounds the input field. The text that surrounds the input field can be a text with a predetermined length before and after the input field.

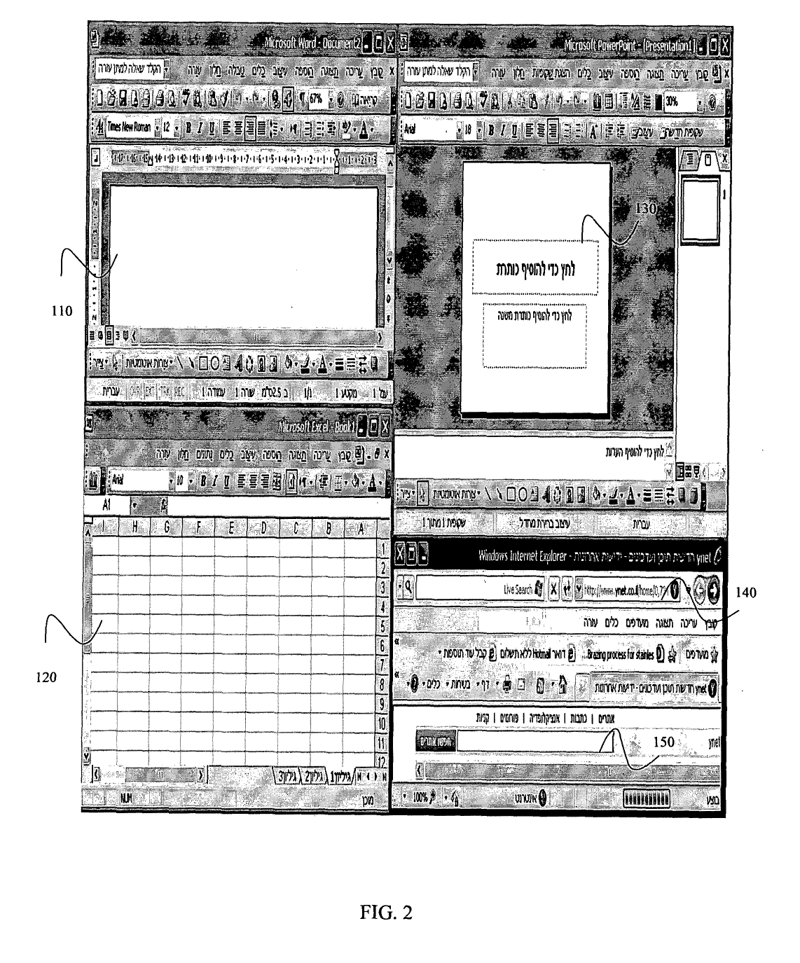

Reference is made now to FIG. 2 where presented different examples of input fields. Input field 110 is document editor file content field. Input field 120 is a spreadsheet software content field. Input field 130 is a presentation file content field. Input field 140 url address field of an internet browser. Input field 150 is a text field in a specific internet page. And example to the importance of the system of the present invention is when a user wants to type a text in field 150. In this case, the user wants to perform a search in Hebrew for in a news site. If before using field 150, the user typed a url address in field 140 in English to reach the specific site, than the default typing language is English. In this case, when clicking on the field 150, the default input language will still be English, and the user will have to press ALT+SHIFT to switch the language to Hebrew. The system of the present invention could do it automatically. In a specific embodiment of the present invention, the tagging algorithm could detect the Hebrew text surrounding the field 150, and switch the default input language to Hebrew automatically. The tagging algorithm could detect that the surrounding text of the field 150 is Hebrew, and therefore tag this field with Hebrew as the default input language.

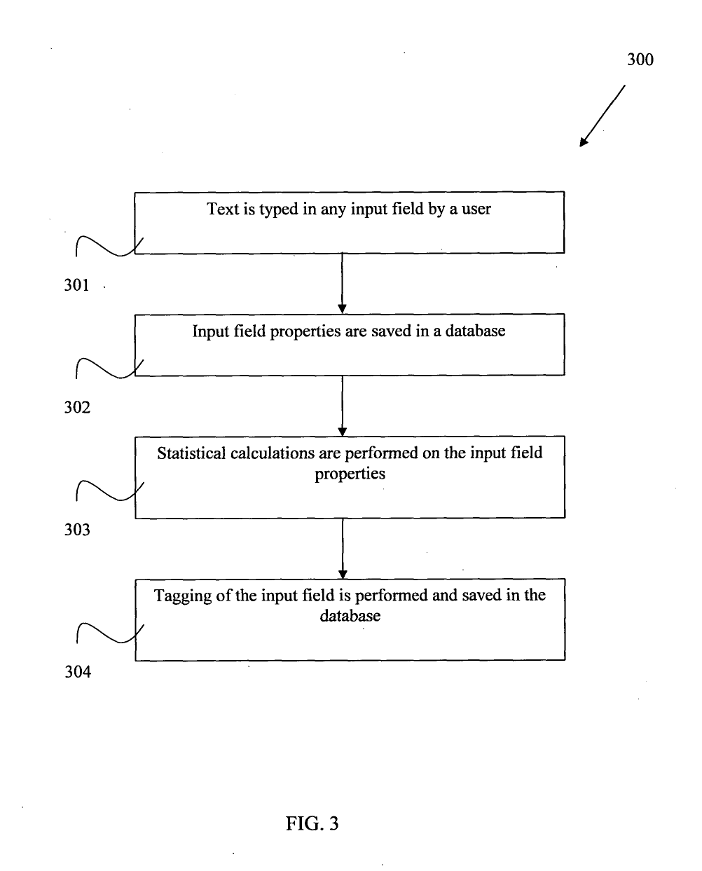

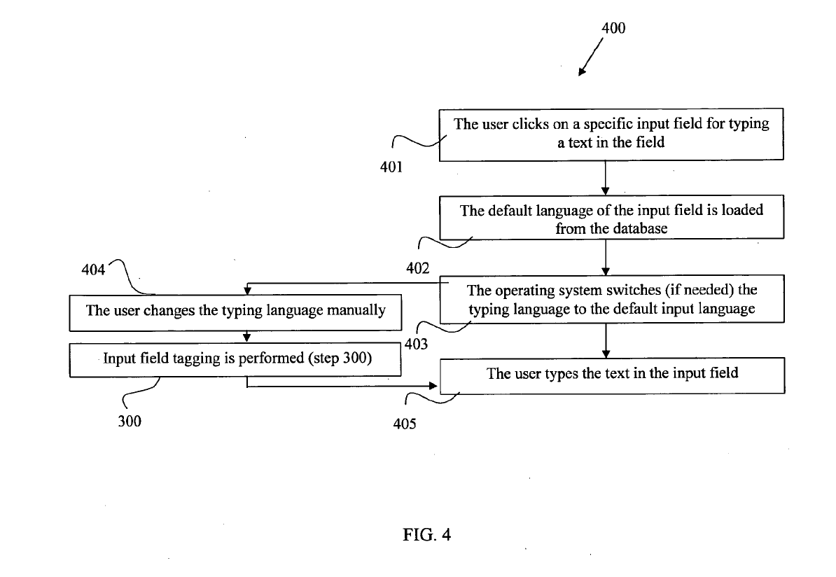

Reference is made now to FIG. 3 where presented the method 300 of the present invention for tagging an input field with a default input language. In this figure it is assumed that the system 100 of the present invention is installed on the operating system 60 (FIG. 1) and is running on the background of the operating system 60 (FIG. 1). The first step of the method 300 is step 301 in which a sequence of text characters is typed in any input field by a user. In the next step 302, input field properties are saved in the database 75 (FIG. 1). The input field properties are for example: the type of the input field, the language properties of the input field, the text typed in the input field, the text surrounding the input field, the caption of the input field, etc. The next step of the method 300 is step 303 in which statistical calculations are performed on the input field properties. The statistical calculations comprise calculations of: Summation, Mean calculation, Variance calculation, Standard Deviation calculation, Expectancy, etc. The last step of method 300 is step 304 in which the tagging of the input field is performed (by the tagging algorithm 52) according to the statistical calculations from step 303 and thresholds (which in a specific embodiment of the system can be predetermined by the user) for decision making. In step 304 the language tag of the input field is saved in the database 75 (FIG. 1) for future use as shown in FIG. 4.

Reference is made now to FIG. 4 where presented the method 400 of the present invention for automatic selection of the typing language by the system 100 (FIG. 1) of the present invention. In this method, the first step is 401 in which the user clicks by the mouse 11 on a specific input field for typing a text in the field, or selects a specific field by the keyboard 10. In the next step 402, the default input language tag of the input field is loaded from the database 75 (FIG. 1). This default input language was predetermined in the method 300. The next step is 403 in which the language selection algorithm 52 changes (if needed) the typing language to the default typing language of the specific input field. In this case, if the default input language is the language that the user wants to write in, step 405 is performed. In this step the used types a text in the input field while the language of the text is the default language. If the default input language that was set by the language selection algorithm 52 is not the language that the user intends to write in, step 404 is performed. In this step the user changes the typing language manually (by pressing ALT+SHIFT or by clicking on an icon on the desktop), and then step 300 is performed. Step 300 is performed to update (if needed) the default typing language. Step 300 is performed in the background of the operating system 60, and the user is not conscious to it. After selection another typing language in step 404, the user types the text in step 405.

1-42. (canceled)

43. A computer system for providing an automatic selection of input language, comprising:
a. a computer operative to execute program code comprising: a monitor, an input means controllable by said user, an operating system with a graphic user interface (GUI) unit adapted to establish interface between said computer and said user;
b. a plurality of text input fields to receiving text characters by said input means; said text input fields and said text characters are displayed on said monitor by said GUI;
c. a plurality of substantially different-typed applications; each of said plurality of applications comprising said plurality of input fields; said plurality of input fields are of substantially different-types; each of said input fields is uniquely identified by pertaining to a specific application;
d. a database located in said computer for storing a type of each said text input field, a language properties of each said input field and a default input language tag of each of said text input field;
e. a tagging algorithm for tagging said default input language for each said text input field; said tagging is according to said properties of said text input filed; and
f. a language selection algorithm for automatic selection of typing language in said text input field to said default input language of said text input field; said language selection is performed in said operating system;
wherein said properties of said text input field are selected from a group consisting of the type of application to which said input text pertains, a document to which said input text pertain, language properties, said type of said input filed, said type of said application, a text surrounding the input field, the type of the input field, a caption of the input field and any combination thereof.

44. The computer system according to claim 43, wherein said memory is selected from a group consisting of the RAM of said computer, the hard-drive of said computer and any combination thereof.

45. The computer system according to claim 43, wherein said memory is the hard-drive of said computer.

46. The computer system according to claim 43, wherein said input means is selected from a group consisting of: a keyboard, a mouse, a touch screen, a hand-writing recognition system that translates hand written scripts to character input or any combination thereof.

47. The computer system according to claim 43, wherein said tagging algorithm is based on statistical calculations and predetermined thresholds; said thresholds are adapted for supporting said tagging algorithm in said tagging.

48. The computer system according to claim 43, wherein said language properties of said input field is the language of said text characters previously received in said input field.

49. The computer system according to claim 48, wherein said previously received is the last time said text characters were received in said input field.

50. The computer system according to claim 43, wherein said language properties are selected from a group consisting of the language of the text that is associated with said input field, the language of the caption of the said input field, the language of the text that surrounds said input field and any combination thereof.

51. The computer system according to claim 47, wherein said statistical calculations are selected from the group consisting of: Summation, Mean calculation, Variance calculation, Standard Deviation calculation, Expectancy calculation and any combination thereof.

52. The computer system according to claim 43, wherein said database further comprising at least one selected from a group consisting of (a) said text characters previously received in said input field with a predetermined number of characters that are saved in said database, (b) the history of said default input language tags of said input field, (c) the text of the name of one of said: document editor file, spreadsheet software file, presentation file and a file of a programming editor; and any combination thereof.

53. The computer system according to claim 47, wherein said statistical calculations are performed on at least one selected from a group consisting of said text characters previously received in said input field, said history of said default input language tags, said text characters, on said text of said name of said file; and any combination thereof.

54. The computer system according to claim 43, wherein said input field is selected from a group consisting of a text field selected from a group consisting of a document editor file content field, a spreadsheet software content field, a presentation file content field, a url address field of an internet browser, a text field in a specific internet page, an input field in a user interface of a computer software, an input field of an operating system, an programming editor, a location of a document editor file, a location of a spreadsheet file, a location of a presentation file, a url address of an internet page, a location of computer software, a location of computer software editable file, a location of an operating system application and any combination thereof.

55. The computer system according to claim 43, wherein said physical medium is selected from a group consisting of: a paper and a monitor.

56. A computer method for providing an automatic selection of input language, comprising:
a. installing a computer system for providing an automatic selection of input language, comprising:
i. a computer operative to execute program code comprising: a monitor, an input means controllable by said user, an operating system with a graphic user interface (GUI) unit adapted to establish interface between said computer and said user;
ii. a plurality of text input fields to receiving text characters by said input means; said text input fields and said text characters are displayed on said monitor by said GUI; each said text input field is uniquely identified by Application/Document/Field triplet;
iii. a database located in the memory of said computer for storing the type of each said text input field, the language properties of each said text input field and the default input language tag of each said text input field;
iv. a plurality of substantially different-typed applications; each of said plurality of applications comprising said plurality of input fields; said plurality of input fields are of substantially different-types; each of said input fields is uniquely identified by pertaining to a specific application;
v. a tagging algorithm for tagging said default input language; wherein the tagging is according to said properties of said text input filed; and,
vi. a language selection algorithm for automatic selection of input language of said text characters in said text input field;
wherein said properties of said text input field are selected from the group consisting of the type of application to which said input text pertains, a document to which said input text pertain, language properties, said type of said input filed, said type of said application, a text surrounding the input field, the type of the input field, a caption of the input field and any combination thereof;
b. actuating said computer system by said execute program code;
c. receiving text characters in said input field by said input means controlled by said user;
d. storing said language properties of said input field to said database;
e. tagging said input field with said default input language by said tagging algorithm; and,
f. selecting said input language of said input field according to said default input language of said input field each time said user selects said input field by said input means.

57. The method according to claim 56, wherein said memory is selected from a group consisting of the RAM of said computer, the hard-drive of said computer and a any combination thereof.

58. The method according to claim 56, wherein at least of the following is being held true (a) said input means is selected from a group consisting of: a keyboard, a mouse, a touch screen or any combination thereof; (b) said tagging algorithm is based on statistical calculations and predetermined thresholds; said thresholds are adapted for supporting said tagging algorithm in said tagging; (c) said language properties of said input field is the language of said text characters previously received in said input field; (d) said previously received is the last time said text characters were received in said input field; and any combination thereof.

59. The method according to claim 56, wherein said language properties are selected from a group consisting of (a) the language of the text that is associated with said input field, (b) the language of the caption of the said input field, (c) the language of the text that surrounds said input field; and any combination thereof.

60. The method according to claim 56, wherein said statistical calculations are selected from the group consisting of: Summation, Mean calculation, Variance calculation, Standard Deviation calculation, Expectancy calculation and any combination thereof.

61. The method according to claim 56, wherein said database further comprising at least one selected from a group consisting of (a) said text characters previously received in said input field with a predetermined number of characters that are saved in said database, (b) the history of said default input language tags of said input field; (c) the text of the name of one of said: document editor file, spreadsheet software file, presentation file and a file of a programming editor; and any combination thereof.

62. The method according to claim 56, wherein said statistical calculations are performed on at least one selected from a group consisting of (a) said text characters previously received in said input field, (b) said history of said default input language tags; (c) said text characters; (d) said text of said name of said file; and any combination thereof.

63. The method according to claim 56, wherein said input field is a text field selected from a group consisting of a document editor file content field, a spreadsheet software content field, a presentation file content field, a url address field of an internet browser, a text field in a specific internet page, an input field in a user interface of a computer software, an input field of an operating system, an programming editor and any combination thereof.

64. The method according to claim 56, wherein said type of said input field is a location of a document editor file, a location of a spreadsheet file, a location of a presentation file, a url address of an internet page, a location of computer software, a location of computer software editable file, a location of an operating system application and any combination thereof.

65. The method according to claim 56, wherein said physical medium is selected from a group consisting of: a paper and a monitor.
